(19) United States
(12) Patent Application Publication
(10) Pub. No.: US 2003/0228504 A1
(43) Pub. Date: Dec. 11, 2003

(54) Method for operating fuel cell system having at least one discontinuously operated fuel cell

(75) Inventors: Gerhard Konrad, Ulm (DE); Michael Niehues, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/436,291

(22) Filed: May 12, 2003

(30) Foreign Application Priority Data
May 13, 2002 (DE) 102 21 146.9

(51) Int. Cl. H01M 8/04; H01M 8/18

(52) U.S. Cl. 429/13; 429/22; 429/21; 429/23

(57) ABSTRACT

In a method for operating a fuel cell system containing at least one discontinuously operated fuel cell the anode of the fuel cell system is supplied with a fuel of nearly pure hydrogen. The nearly pure hydrogen contains only small proportions of carbon monoxide and, possibly, inert components. After shutting down the fuel cell, an oxidizing agent is fed into the region of the anode of the fuel cell, for example, in a manner integrated into a shut-down cycle.

Priority is claimed to German patent application 102 21 146.9, filed May 13, 2002, and the subject matter of which is hereby incorporated by reference herein.

The present invention relates to a method for operating a fuel cell system having at least one discontinuously operated fuel cell, an anode of the fuel cell being supplied with a fuel to which is added an oxidizing agent in metered quantities.

### BACKGROUND

From U.S. Pat. No. 6,210,820 B1, it is known to add oxygen or air as an oxidizing agent to the fuel inflow of a fuel cell to oxidize impurities, in particular carbon monoxide (CO), contained in the fuel. This so-called “air bleed” avoids poisoning of the catalysts in the anode region of PEM fuel cells by the impurities. In this manner, the fuel cell performance can be maintained even with comparatively high concentrations of carbon monoxide of, for example, up to 1000 parts per million (ppm).

However, this air bleed is bought at the expense of the presence of inert and other gas components in the fuel that cannot be converted by the fuel cell so that the efficiency of the fuel cell decreases with higher air bleed levels. Therefore, the above-mentioned US patent makes use of an air bleed which is carried out as a function of the impurity of the fuel and by which oxygen or air is metered into the fuel in as small quantities as possible. The sensor used for the impurity of the combustion gas is a special fuel cell as a sensor cell among many other fuel cells of a fuel cell stack, the special fuel cell responding in a correspondingly more sensitive manner than the other fuel cells to poisoning of its catalysts with carbon monoxide. When this sensor cell is noted to have a drop in performance1, this drop in performance serves as a measure for the start of the air bleed. At this time, the other fuel cells still deliver full power. Since the poisoning in the fuel cell system is reversible, it can be removed again by the air bleed.

The above-mentioned U.S. patent indicates that a comparable cleaning effect can be achieved by a periodically pulsed air bleed introducing less oxygen or air than with a continuous air bleed.

When operating a fuel cell system in dead-end mode on the anode side or with a recirculation of the combustion gas still present downstream of the anode into the region upstream of the anode, then inert gases, such as forming carbon dioxide, nitrogen, etc., will accumulate in the region of the anode with increasing operating time due to the air bleed. The fuel concentration decreases. In order to obtain a sufficiently high fuel concentration again for operating the fuel cell, purging needs to be done at regular intervals, i.e., the gases have to be discharged from the recirculation or the region of the anode.

However, the achievable efficiency of the fuel cell is disadvantageously affected during operation, first by the accumulation of the inert gas components, then by the fuel loss during purging.

Moreover, it is known from the prior art that a large part of the fuel cell systems used are operated discontinuously, that is, not in an uninterrupted manner. Examples of this are, for instance, fuel cells systems in motor vehicles, vessels or aircraft which are used there for purposes of propulsion or else as auxiliary power units (APU). Usually, such fuel cell systems, or at least the fuel cells contained therein, for example, in a hybridized power supply using fuel cells and batteries, have phases in which they are operated, i.e., electrical power is demanded from them, and idle phases in which they do not supply electrical power.

### SUMMARY OF THE INVENTION

An object of the present invention is to improve the efficiency of operation of a fuel cell system containing at least one discontinuously operated fuel cell in which an anode of the fuel cell is supplied with a fuel, an oxidizing agent being added to the fuel in metered quantities.

The present invention provides a method for operating a fuel cell system having at least one discontinuously operated fuel cell in which nearly pure hydrogen, which can contain small proportions of carbon monoxide and, possibly, of inert components, is used as the fuel, the oxidizing agent being supplied after the end of the electrical power demand from the fuel cell.

Each gas volume produced by an air bleed or by addition of oxygen or another oxidizing agent and consisting of gases that cannot be converted in the region of the anode reduces the hydrogen concentration or the partial pressure of the hydrogen in the region of the anode. Therefore, the conversion of the hydrogen decreases and therefore ultimately also the efficiency of the fuel cell. In parallel to this, the efficiency decreases because the catalytically active centers in the region of the anode become coated, for example, with carbon monoxide. In order to counteract this poisoning of the noble metal catalysts in the region of the anode, it is possible to add an oxidizing agent, such as air, (so-called air bleed), according to the prior art and together with the above-mentioned disadvantages.

According to the present invention, an oxidizing agent is, in fact, added as well, but not continuously or at short periodic intervals, but discontinuously when the fuel cell is shut down. The addition of the oxidizing agent, which, according to an embodiment of the present invention is air, can take place, for example, in a shut-down cycle. In this case, then, the quantity of oxidizing agent introduced and of inert gases that are perhaps unintentionally introduced as well, such as nitrogen when using air as the oxidizing agent, are irrelevant to the efficiency of the fuel cell. Since the poisoning of the anode by the carbon monoxide is reversible, this carbon monoxide, which blocks the catalytically active centers, can be oxidized to carbon dioxide and discharged to the environment.

To be able to use the method according to the present invention in a useful way, it is required to use a fuel containing only small proportions of carbon monoxide; “small proportions” being understood here to be less than 100 parts per million (ppm) or preferably markedly less than 50 ppm. This low content of carbon monoxide will, in fact, poison the anode of the fuel cell during its operation, that is, coat the catalytically active centers of its catalysts, but the process takes place slowly. Before the anode is poisoned to such a degree that the poisoning is perceived to have a very disturbing effect on the power delivered by the fuel cell, the fuel cell is, in the normal case, already shut down due to its discontinuous mode of operation.

After shutting down the fuel cell, the oxidizing agent is supplied and the anode will recover from the poisoning. After the fuel cell is restarted, it can therefore be operated normally again. According to the present invention, air bleeding during the operation of the fuel cell and the associated efficiency losses can therefore be dispensed with.

According to an embodiment of the method according to the present invention, the quantity of oxidizing agent supplied is adjusted as a function of the known carbon monoxide content of the fuel and as a function of the power drawn from the fuel cell.

Usually, the source of the nearly pure hydrogen as the combustion gas is known in all operating phases of the fuel cell system. Therefore, in particular, the proportion or at least the order of magnitude of the proportion of carbon monoxide in the fuel is known as well. Thus, depending on the power drawn from the fuel cell, the anode will be poisoned by the carbon monoxide to different degrees. According to this particularly favorable embodiment of the present invention, the quantity of oxidizing agent supplied is determined as a function of this known carbon monoxide content of the fuel and as a function of the power drawn from the fuel cell. In this manner, the quantity of oxidizing agent can be ideally adapted to the specific anode poisoning that has occurred so that the regeneration of the anode can be achieved with minimum effort.

The quantity of oxidizing agent can be adjusted, for example, on the basis of the duration of the supply of oxidizing agent, for example, based on the opening duration of a solenoid valve or the like.

In addition or as an alternative to the just-described embodiment of the present invention, in an embodiment of the inventive method, the oxidizing agent can also be supplied as a function of a quantity that is characteristic of the presence of carbon monoxide.

Thus, as an alternative or as additional support, it is also achieved to make possible as ideal a regeneration as possible together with as complete as possible a conversion of the carbon monoxide present in the region of the anode.

In an embodiment of the inventive method, provision is made to use the concentration of oxidizing agent in the region of the anode as the quantity characteristic of the presence of carbon monoxide.

This concentration of the oxidizing agent is generally much easier to measure than the concentration of the carbon monoxide itself because the sensors usually used for this purpose are highly cross-sensitive, in particular, to the also present hydrogen. In contrast, the concentration of the oxidizing agent, such as oxygen, can be measured easily. For this purpose, it is possible to use, for example, Lambda sensors as are already used in great numbers in internal combustion engines for open-loop and closed-loop control. When using such a sensor to determine the concentration of the oxidizing agent, it being particularly useful to arrange the sensor downstream of the passage through the region of the anode, it is now assumed that the, at least approximately, largest part of the carbon monoxide reacts with the oxidizing agent. If then, no oxidizing agent is present anymore, such a reaction can no longer take place, and it is required to add oxidizing agent again for this purpose. A concentration of oxidizing agent which corresponds to the addition of oxidizing agent can thus be interpreted such that the existing carbon monoxide is already oxidized so that there is no need to add further oxidizing agent.

In an embodiment of the present invention, a suitable sensor for determining the quantity of carbon dioxide (CO₂) can also be used in place of a sensor for determining the quantity of oxidizing agent. These sensors can also have a simple design, in particular, a much simpler design than sensors for carbon monoxide. Then, it is possible to add oxidizing agents until a corresponding concentration of carbon dioxide is reached which, at least approximately, suggests a complete oxidation of the carbon monoxide present.

Besides using the here described quantities of carbon dioxide or oxidizing agent as quantities characteristic of the presence of carbon dioxide, other quantities could possibly be correspondingly suitable here as well.

According to an embodiment of the method according to the present invention, the oxidization of the carbon monoxide is supported by increasing the temperature of the substances involved.

This can be done, for example, by preheating the oxidizing agent supplied. Due to the higher thermal energy content of the substances involved, a higher activity of these substances is achieved, so that the desired oxidation of the carbon monoxide and a corresponding release of carbon monoxide covering the catalysts of the anode are supported, facilitating the regeneration of the poisoned anode.

According to an embodiment of the method according to the present invention, a similar effect can also be achieved by applying a voltage to the electrodes of the fuel cell.

This voltage, which serves as an alternative support or in addition to the above-mentioned increase of temperature, also increases the activity of the substances involved, so that oxidation of the carbon monoxide is correspondingly facilitated and thus able to proceed in a shorter time.

The particular advantage of this improvement of the oxidation by increasing the activity of the substances involved is now that the whole process is shortened in time so that, in particular, the regeneration of the anode can be integrated into a short shut-down cycle of the fuel cell system or of the fuel cell in a simple way.

### BRIEF DESCRIPTION OF THE DRAWING

The present invention is elaborated upon below based on exemplary embodiments with reference to the drawings, in which:

FIG. 1 shows a schematic design of a fuel cell system that can be used to carry out the method according to the present invention.

### DETAILED DESCRIPTION

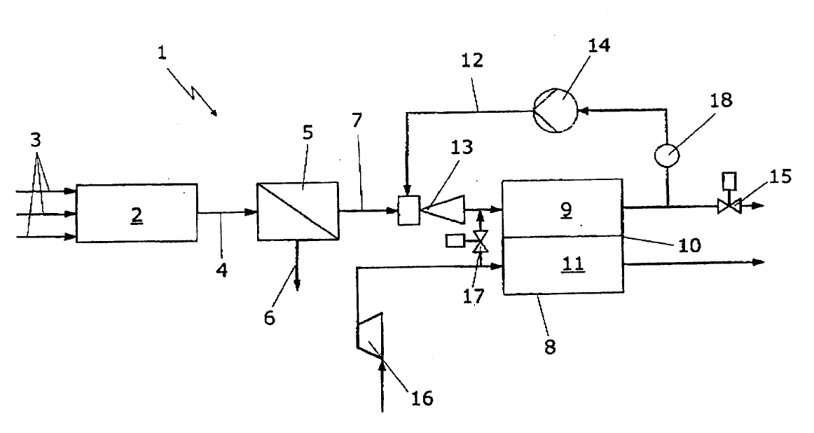

FIG. 1 shows a fuel cell system 1, which can be designed, for example, as an auxiliary power unit (APU) having a typical power output of 2 to 25 kW. This auxiliary power unit can be used, in particular, in a vehicle, a vessel, or the like, to supply power to electrical loads there. In principle, such a fuel cell system 1, together with the method to be described below, can also be used for other applications, for example, propulsion purposes, self-contained power supply systems, or the like.

In the example of fuel cell system 1 described here, hydrogen-containing reformate is produced in a gas generation system 2, for example, from air, water and a hydrocarbonaceous compound, such as gasoline or Diesel fuel, which are symbolized by the three supply lines 3. The reformate produced in gas generation system 2 then reaches the region of a membrane module 5 via an indicated line 4. In membrane module 5, the hydrogen-rich reformate, which was produced in gas generation system 2, for example, by an autothermal reformer including downstream shift stages or the like, is split into nearly pure hydrogen and a residual gas, the so-called retentate. Via line 6, the retentate reaches, for example, the region of a burner for supplying energy for the heating of gas generation system 2.

Via line 7, the actual fuel, which, after passing through membrane module 5 is nearly pure hydrogen, reaches the region of a fuel cell 8, and here, in particular, the region of an anode 9 of fuel cell 8, which is designed as a PEM fuel cell, the anode being separated from a cathode 11 of fuel cell 8 by a proton-conducting membrane 10 in a manner known per se. In this context, fuel cell 8 can be understood to be both a single fuel cell and a fuel cell stack composed of a plurality of individual fuel cells.

As mentioned above, the fuel fed to anode 9 via line 7, is nearly pure hydrogen after it has passed membrane module 5. The fuel can additionally contain small proportions of inert components and will generally also contain a very small proportion of carbon monoxide. This small proportion of carbon monoxide can be explained, for example, by minimal leaks in the region of membrane module 5, or the like. Generally, however, it will be markedly below 50 to 100 ppm, in particular, on the order of 10 ppm or less.

In fuel cell system 1 shown here, the nearly pure hydrogen, after passing through the region of anode 9, is now returned, in a circuit 12, to the region where the fuel enters anode 9. Residual hydrogen, which has not been converted while passing through anode 9, is returned to anode 9 again by this circuit 12, allowing conversion of all hydrogen reaching the region of fuel cell 8 from the region of membrane module 5. Usually, in this context, an amount on order of 10 to 40% of the hydrogen fed to anode 9 is not converted and is returned through circuit 12. The driving mechanism provided for circuit 12 is a gas-jet pump or jet pump 13. This pump can be assisted by or replaced with an optional circulating pump 14 when or if this should be required permanently or in certain operating states of fuel cell 8.

Moreover, circuit 12 has a valve 15 by which unwanted substances accumulating in the circuit 12 can be discharged from time to time. In prior art fuel cell systems, this process, which is referred to as “purging”, is required from time to time, as already mentioned at the outset.

Furthermore, fuel cell system 1 described here contains a compressor 16 for air supply to cathode 11 or fuel cell 8, as well as a schematically indicated valve 17 for carrying out an air bleed, which will be explained later.

In this context, circuit 12 of fuel cell system 1 shown here is to be considered only as an option because this is the usual mode of operation of a fuel cell 8 if it can be operated with nearly pure hydrogen as the fuel. In principle, however, the method explained below is also suitable for operating a fuel cell system 1 without circuit 12 so that the method is not limited to the design of the exemplary embodiment shown here.

In the region of anode 9 of fuel cell 8, the admittedly small, but nevertheless possibly present proportion of carbon monoxide in the fuel results in a gradual poisoning of the catalyst present in the region of anode 9. These catalysts, which are generally designed as noble metal catalysts, become coated with the carbon monoxide in the region of their catalytically active centers, thus being inhibited in their activity. In the case of the nearly pure hydrogen used here, which contains only small quantities of carbon monoxide, this so-called “poisoning” of anode 9 occurs very slowly. A common air bleed according to the prior art, that is, the addition of an oxidizing agent, for example, air from the region of the air supply to cathode 11 through valve 17, during the operation of fuel cell 8 in order to oxidize the carbon monoxide present, can be dispensed with in the case of fuel cell system 1 shown here. The therefore required purging operations through valve 15, by which the inert gas components forming and/or accumulating in circuit 12 are discharged to the environment, thereby also wasting a residue of hydrogen which has not yet been converted, can be avoided as well.

During the operating phase of fuel cell 8, that is, when electrical power is demanded and drawn from the fuel cell, the gradual poisoning by the small proportions of carbon monoxide in the fuel is now accepted. Only when no more power demand is placed on fuel cell 8, that is, when fuel cell system 1 or at least fuel cell 8 itself shut down, an oxidizing agent is fed into the region of anode 9 or into circuit 12. In this context, the oxidizing agent can be added, in particular, immediately upstream of the entrance to anode 9 so that quantities of carbon monoxide present therein and deposited on the catalysts thereof are oxidized to carbon dioxide by the oxidizing agent. This gas is then discharged to the environment by opening valve 15. Optionally, it can be circulated several times through circuit 12 in advance to ensure complete oxidation of the carbon monoxide present.

The oxidizing agent used can be, for example, air which can be drawn from the region of supply to other components of the gas generation system, for example, the air supply to reformers, selective oxidizing stages or, in particular, also from the region of the air supply for cathode 11. In the exemplary embodiment shown here, the oxidizing agent used is air from the region of the air supply for cathode 11 so that in order for the oxidizing agent to be fed into the region of anode 9, it is only required to open valve 17. This air-bleed operation for regenerating the poisoned anode 9 can, for example, be integrated into a shut-down cycle of the entire fuel cell system 1, especially because during shutdown, the fuel cell system, having the gases and the thermal energy contained therein, must anyway be run down to a defined state. This time and the residual energy still present can be used for carrying out the air bleed in the span of this shutdown cycle.

Adding the oxidizing agent during the shut-down cycle eliminates the need to add such an oxidizing agent while fuel cell 8 is in operation. This oxidizing agent, in particular if it is air, would result in a corresponding accumulation of carbon dioxide and inert gas components, in particular nitrogen, in circuit 12, reducing the partial pressure of the hydrogen that is also still contained in circuit 12 to such an extent that a reasonable conversion of the hydrogen in fuel cell 8 is no longer possible. In case of a correspondingly high accumulation of inert components, the content of the circuit would therefore have to be discharged through valve 15 regularly and very frequently, resulting in corresponding efficiency losses of the overall system due to the loss of the hydrogen that is still contained in circuit 12.

In the method described here, in which the oxidizing agent is added only after end of the electrical power demand from fuel cell 8, this can be avoided because only residual gases are discharged which would be lost anyway during the defined shutdown of fuel cell system 1.

As an alternative to the already mentioned air as the oxidizing agent, for example, pure oxygen or oxygen-enriched air could be used as well, it being possible for this oxygen to be produced, for example, by electrolysis from the process water of the fuel cell or else by a chemical conversion of oxygen-containing starting materials. In connection with this conversion of oxygen-containing starting materials, it is possible to conceive of a conversion of hydrogen peroxide to oxygen and water, or of a corresponding conversion of other oxygen-containing starting materials, for example, a thermal decomposition of oxygen-containing chemicals such as potassium permanganate.

As an alternative to this, the oxygen can also be obtained from the air by applying electrical power to a ceramic oxygen conductor; this principle, being basically known in a reciprocal manner from Lambda sensors and ceramic electrolytes, for example, in solid oxide fuel cells (SOFC).

Independently of the type of oxidizing agent used, the quantity of oxidizing agent present is responsible for anode 9 to be fully regenerated so that the quantity of oxidizing supplied should be adjusted. Since the production of the nearly pure hydrogen as the fuel is generally carried out in a very similar and reproducible manner, at least the order of magnitude of the carbon monoxide concentration in the fuel can be estimated, or is known anyway. Therefore, the poisoning of anode 9 can be visualized as a function of this estimated/known carbon monoxide content of the fuel and as a function of the electrical power drawn from fuel cell 8, as a measure for the quantity of hydrogen converted, because the quantity of carbon monoxide reaching the region of anode 9 can be estimated.

On the basis of these values, it is now possible to adjust the quantity of oxidizing agent that is introduced into the region of anode 9 after shutting down fuel cell 8. This can be accomplished, for example, by means of the time span in which metering takes place; that is, in the exemplary embodiment shown here, for example, by means of the opening duration of valve 17, in particular, because the pressure conditions in the region of the air supply to cathode 11 are generally known and the quantity of oxidizing agent supplied can therefore be adjusted by a simple control of the opening duration.

When using pure oxygen as the oxidizing agent, the quantity of oxidizing agent can also be adjusted by the length of the time period of oxygen production. Both in the case of electrolysis and in the case of oxygen-conducting ceramics, and of electrical heating of thermally decomposable chemical oxygen carriers, this can be controlled, for example, by means of the electrical power introduced. Moreover, a sensor 18, as optionally indicated in circuit 12, can be provided to assist in this simple control of the quantity of oxidizing agent introduced. Using this sensor 18, it is possible, for example, to measure a quantity characteristic of the presence of carbon monoxide. The carbon monoxide concentration itself is comparably difficult to determine because usual sensors operate with relatively low precision and, moreover, are highly cross-sensitive to hydrogen, which is generally present in a comparably large quantity. Therefore, for example, the presence of carbon dioxide after the addition of oxidizing agent can also be used as a quantity characteristic of the presence of carbon monoxide. The detection of carbon dioxide is correspondingly easier, and this carbon dioxide forms from the carbon monoxide upon addition of the oxidizing agent; therefore, the concentration of carbon dioxide makes it possible to draw corresponding conclusions on the remaining concentration of carbon monoxide.

As an alternative to this, it would also be possible, for example, to measure the concentration of oxidizing agent in the region of the anode or, in particular, of circuit 12. Thus, for example, sensors for measuring the oxygen concentration are generally already widespread and very frequently used as Lambda sensors in internal combustion engines. Using this rugged sensor, which is manufactured in large numbers and is therefore simple and inexpensive, it is accordingly possible to measure the concentration of oxidizing agent. It is now assumed that the oxidizing agent introduced is used up as long as carbon monoxide is present. However, if a very high concentration of oxidizing agent arises, it can be assumed that the carbon monoxide is largely converted.

If the ceramic oxygen conductor for adding oxygen, which has already been mentioned above, is used either to enrich air or as the only oxidizing agent, this ceramic oxygen conductor can, in principle, be also used as a sensor for the oxygen concentration. Therefore, the ceramic oxygen conductor and the Lambda sensor can be designed as one integrated component which could then be used alternately in time, either as a sensor or as a proportioning means. Since ceramic oxygen conductors generally require higher temperature, it would be possible, for example, to combine this with an electrical heating of the sensor or ceramic oxygen conductor, in particular, only when oxygen is added.

In order to oxidize the carbon monoxide present to carbon dioxide in as ideal and complete a manner as possible, it can also be useful to condition the involved substances to this effect, for example, by heating. In particular, when using air as the oxidizing agent, this could be accomplished by correspondingly preheating the air prior to feeding it into anode 9. In case of the already addressed integration of the air bleed into a shut-down cycle of fuel cell system 1 or of fuel cell 8, it is possible to use, for example, residual heat, which is anyway present in fuel cell system 1, for preheating the oxidizing agent without additional expenditure of energy. The supply of the heat to the oxidizing agent can be accomplished, for example, via heat exchangers in the supply line or in circuit 12. When using the ceramic oxygen conductor, which will generally require heating anyway to ensure its functionality, this heating can also contribute to the heating of the media in circuit 12.

As an alternative or complement to this, it could also be made possible for the carbon monoxide deposited in the region of the catalysts to be released and, thus, to be oxidized to carbon dioxide more easily by applying an electrical voltage to fuel cell 8.

The arrangement of the metering point for the oxidizing agent immediately upstream of the entrance into the region of anode 9 and of sensor 18 after the passage of the oxidizing agent through anode 9 is particularly convenient for the implementation of the method because the carbon monoxide will predominantly be in the region of anode 9 and can be oxidized to carbon dioxide there. If, after passage through the region of the anode, a correspondingly high level of carbon monoxide should be present or if the levels used as quantities characteristic of the presence of carbon monoxide should be correspondingly low, then additional oxidizing agent can immediately be metered into the region of anode 9.

In the preceding specification, the present invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for operating a fuel cell system including at least one discontinuously operated fuel cell, the method comprising:
supplying an anode of the at least one fuel cell with a fuel including nearly pure hydrogen; and
supplying an oxidizing agent to the supplied fuel in metered quantities after an end of an electrical power demand from the at least one fuel cell.

2. The method as recited in claim 1 wherein the nearly pure hydrogen includes at least one of a small proportion of carbon monoxide and an inert component.

3. The method as recited in claim 1 wherein the supplying the oxidizing agent is performed so as to adjust a quantity of the oxidizing agent supplied as a function of a known carbon monoxide content of the fuel and as a function of electrical power drawn from the at least one fuel cell.

4. The method as recited in claim 1 wherein the supplying the oxidizing agent is performed as a function of a quantity characteristic of a presence of carbon monoxide.

5. The method as recited in claim 4 wherein the quantity characteristic of the presence of carbon monoxide includes a concentration of the oxidizing agent in a region of the anode.

6. The method as recited in claim 4 wherein the quantity characteristic of the presence of carbon monoxide includes a concentration of carbon dioxide in a region of the anode.

7. The method as recited in claim 1 further comprising achieving a proportion of carbon monoxide of substantially less than 50 ppm in the fuel by passing the supplied fuel through a membrane module upstream of a region of the anode.

8. The method as recited in claim 7 wherein the proportion of carbon monoxide in the fuel is less than 10 ppm.

9. The method as recited in claim 1 wherein the nearly pure hydrogen includes a small proportion of carbon dioxide and further comprising supporting an oxidization of the carbon monoxide by increasing a temperature of the oxidizing agent.

10. The method as recited in claim 1 wherein the nearly pure hydrogen includes a small proportion of carbon dioxide and further comprising supporting an oxidization of the carbon monoxide by applying a voltage to the anode and a cathode of the at least one fuel cell.

11. The method as recited in claim 1 wherein the supplying the oxidizing agent is performed by feeding in the oxidizing agent immediately upstream of an entrance of the fuel into a region of the anode.

12. The method as recited in claim 1 further comprising conveying at least a portion of the fuel to a region of the anode in a return circuit.

13. The method as recited in claim 12 further comprising opening the return circuit after an end of the electrical power demand from the at least one fuel cell so as to discharge residual gases.

14. The method as recited in claim 1 wherein the oxidizing agent includes air.

15. The method as recited in claim 14 further comprising providing the air from a region of air supply to other components of the fuel cell system.

16. The method as recited in claim 1 wherein the oxidizing agent includes at least nearly pure oxygen.

17. The method as recited in claim 16 further comprising sensing a concentration of oxygen in the at least nearly pure hydrogen using a Lambda sensor.

18. The method as recited in claim 16 further comprising producing the at least nearly pure oxygen using electrolysis of water.

19. The method as recited in claim 16 further comprising producing the at least nearly pure oxygen by chemical conversion of oxygen-containing starting materials.

20. The method as recited in claim 16 further comprising producing the at least nearly pure oxygen from air using a ceramic oxygen conductor and electric energy.

21. The method as recited in claim 20 further comprising sensing a concentration of oxygen in the at least nearly pure hydrogen using a Lambda sensor, the ceramic oxygen conductor and the Lambda sensor forming an integrated component useable alternately in time as a sensor and as an oxygen proportioning means.

22. The method as recited in claim 1 further comprising operating the fuel cell system as an auxiliary power unit.

23. The method as recited in claim 22 wherein the auxiliary power unit is disposed in at least one of a land vehicle, a watercraft and an aircraft.
